(19) United States
(12) Patent Application Publication
(10) Pub. No.: US 2017/0213242 A1
(43) Pub. Date: Jul. 27, 2017

(54) Computer-implemented method of and system for running a marketing campaign

(71) Applicant: COMMUNIKATE DIGITAL CHANNEL GROUP PTE LTD, Singapore (SG)

(72) Inventors: Radhika SUNDARAM, Singapore (SG); Rambacthavachalam Dhakshna MOORTHY, Singapore (SG)

(21) Appl. No.: 15/328,474

(22) PCT Filed: Jul. 23, 2014
(86) PCT No.: PCT/SG2014/000346

§ 371 Date: Jan. 23, 2017

(51) Int. Cl. G06Q 30/02; H04L 29/08; H04L 12/26

(52) U.S. Cl. CPC G06Q 30/0246; H04L 43/08; H04L 67/22; H04L 67/141

(57) ABSTRACT

A computer-implemented method and system (10) for running a marketing campaign are provided. The method is performed by one or more servers (12) communicatively coupled to a computer network (14). The method includes receiving a campaign specification, a recipient specification, a selection of one or more communication channels in which to run the marketing campaign, a campaign flow specification, and a content specification for each of the one or more selected communication channels from a client computer (18). The campaign specification specifies one or more attributes of the marketing campaign, the recipient specification specifies one or more desired attributes of a plurality of targeted campaign recipients (20), the campaign flow specification specifies an order in which to execute the marketing campaign in the one or more communication channels, and the content specification specifies content to be sent to the targeted campaign recipients The marketing campaign is executed in the one or more selected communication channels according to the specified order. Campaign data is obtained from the targeted campaign recipients (20) and analysed. A report is generated for the client computer (18) based on the analysed campaign data.

### FIELD OF THE INVENTION

The present invention relates in general to marketing automation and more particularly to a computer-implemented method of and system for running a marketing campaign.

### BACKGROUND OF THE INVENTION

The advancement of digital communications over the past decade has enabled brand marketers to reach wider audiences over shorter time frames and with more personalized messaging. The penetration of mobile technology across global markets, the exponential growth of social media marketing, and the latest trends in Internet usage are all manifestations of this phenomenon. However, this has also increased the burden on marketers to manage, measure, and track their communication campaigns across a myriad of touch points and channels.

In view of the foregoing, it would be desirable to have a computer-implemented method of and system for running a marketing campaign that provide a common platform over which digital communications from a brand to its audiences can be managed, tracked and measured across one or more channels.

### SUMMARY OF THE INVENTION

Accordingly, in a first aspect, the present invention provides a method of running a marketing campaign. The method is performed by one or more servers communicatively coupled to a computer network. The method includes receiving a campaign specification from a client computer, the campaign specification specifying one or more attributes of the marketing campaign, receiving a recipient specification from the client computer, the recipient specification specifying one or more desired attributes of a plurality of targeted campaign recipients, receiving a selection of one or more communication channels in which to run the marketing campaign from the client computer, receiving a campaign flow specification from the client computer, the campaign flow specification specifying an order in which to execute the marketing campaign in the one or more communication channels, receiving a content specification for each of the one or more selected communication channels from the client computer, the content specification specifying content to be sent to the targeted campaign recipients, and executing the marketing campaign in the one or more selected communication channels according to the specified order. Campaign data is obtained from the targeted campaign recipients. The campaign data obtained from the campaign recipients is analysed, and a report is generated for the client computer based on the analysed campaign data.

In a second aspect, the present invention provides a system for controlling running a marketing campaign. The system includes one or more servers communicatively coupled to a computer network. The one or more servers are configured to receive a campaign specification from a client computer, the campaign specification specifying one or more attributes of the marketing campaign, receive a recipient specification from the client computer, the recipient specification specifying one or more desired attributes of a plurality of targeted campaign recipients, receive a selection of one or more communication channels in which to run the marketing campaign from the client computer, receive a campaign flow specification from the client computer, the campaign flow specification specifying an order in which to execute the marketing campaign in the one or more communication channels, receive a content specification for each of the one or more selected communication channels from the client computer, the content specification specifying content to be sent to the targeted campaign recipients, execute the marketing campaign in the one or more selected communication channels according to the specified order, obtain campaign data from the targeted campaign recipients, analyse the campaign data obtained from the campaign recipients, and generate a report for the client computer based on the analysed campaign data.

Other aspects and advantages of the invention will become apparent from the following detailed description, taken in conjunction with the accompanying drawings, illustrating by way of example the principles of the invention.

### BRIEF DESCRIPTION OF THE DRAWINGS

Embodiments of the invention will now be described, by way of example only, with reference to the accompanying drawings, in which:

FIG. 1 is a schematic block diagram illustrating a system for running a marketing campaign in accordance with one embodiment of the present invention;

FIG. 2 is a schematic block diagram of one of the servers of the system of FIG. 1; and

FIG. 3 is a schematic flow diagram illustrating a method of running a marketing campaign in accordance with one embodiment of the present invention.

### DETAILED DESCRIPTION OF EXEMPLARY EMBODIMENTS

The detailed description set forth below in connection with the appended drawings is intended as a description of presently preferred embodiments of the invention, and is not intended to represent the only forms in which the present invention may be practiced. It is to be understood that the same or equivalent functions may be accomplished by different embodiments that are intended to be encompassed within the scope of the invention.

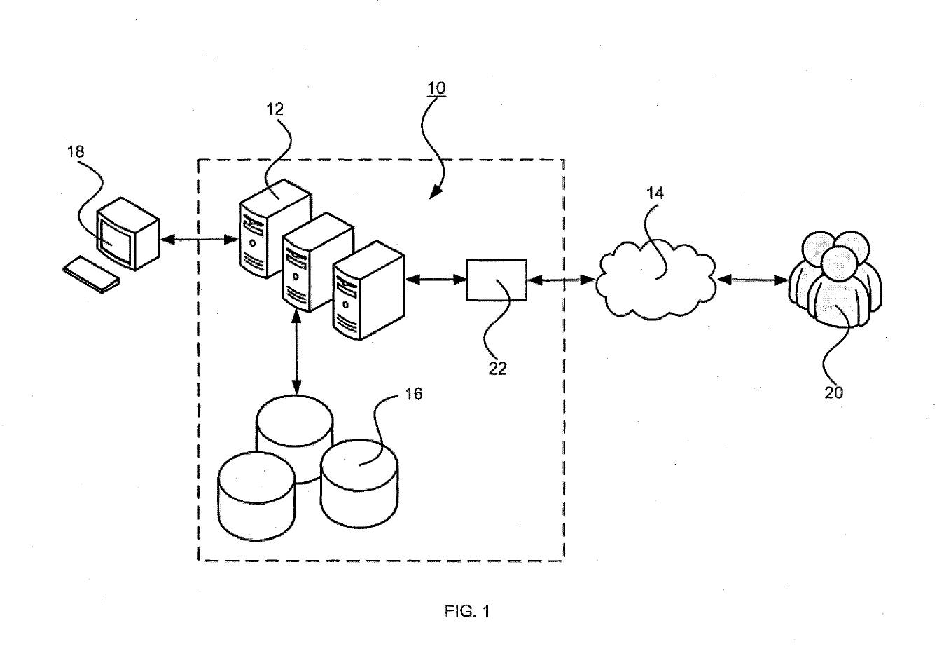

Referring now to FIG. 1, a system 10 for running a marketing campaign is shown. In the present embodiment, the system 10 includes a plurality of servers 12 communicatively coupled to a computer network 14 and a plurality of databases 16 storing potential campaign recipient records. The servers 12 are configured to receive a campaign specification, a recipient specification, a selection of one or more communication channels in which to run the marketing campaign, a campaign flow specification and a content specification for each of the one or more selected communication channels from a client computer 18. The servers 12 are configured to execute the marketing campaign in the one or more selected communication channels according to the specified order, obtain campaign data from a plurality of targeted campaign recipients 20, analyse the campaign data obtained from the campaign recipients 20, and generate a report for the client computer 18 based on the analysed campaign data. In the present embodiment, the system 10 also includes a load balancer 22 communicatively coupled to the servers 12, the load balancer 22 being configured to assess a processing load on the servers 12 and to service jobs in a queue. In one embodiment, the load balancer 22 may be configured to route a client marketer to a respective system location based on user proximity and/or local data privacy policy.

The servers 12 are configured to manage the internal processes within the system 10 at the points of campaign definition and setup, delivery and tracking. One or more of the servers 12 may be configured to enable external integrations to systems such as SalesForce, databases and social media channels as well as provide a web interface to access the system 10. In one embodiment, when a user logs in and initiates actions on the system 10, a first or application server 12 receives and processes one or more requests from the client computer 18 and routes the one or more requests to a second or job server 12 for execution. In such an embodiment, the job server 12 may be configured to act as a hub to complete data transactions for system activities. The job server 12 may also be configured to help create data in the form of campaigns that the job server 12 helps to publish.

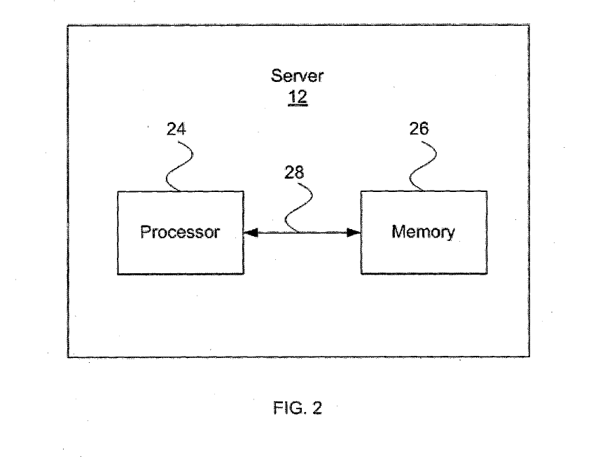

Referring now to FIG. 2, a schematic block diagram of one of the servers 12 is shown. In the embodiment shown, the server 12 includes a processor 24 and a memory 26 coupled to the processor 24 via a bus 28. As server computers are well known to those of ordinary skill in the art, detailed description of the hardware configuration of the server 12 is not required for a complete understanding of the present invention.

Referring again to FIG. 1, the computer network 14 may be any type of computer network such as, for example, the Internet. The computer network 14 may be a hard-wired network, a wireless network such as, for example, a cloud-based network, or a combination of both.

The databases 16 in the present embodiment may be configured to store recipient data, campaign data, user data, industry data and administrative data. The data stored in the databases 16 may be structured and/or unstructured. The databases 16 may also be configured to hold data aggregated and interpreted from across the targeted campaign recipients 20, one or more communication channels and campaign activities. The potential campaign recipient records may be added to the one or more databases 16 by one or more of manual data entry, data file upload and data extraction from one or more external sources.

The client computer 18 may be any computing device having wired or wireless connectivity such as, for example, a desktop computer, a laptop computer, a smart phone or a tablet computer.

The recipients 20 for a campaign may be selected from recipient lists stored in the databases 16. The recipient lists may contain recipient records containing data related to contact details (for example, name, contact number, email address and social handles), demography (such as age and gender) and geography (for example, location, city and country). Key primary contact details may be stored in relational database servers using 256 bit-encryption. Additionally, the recipient records may also be associated with other secondary information such as customer relationship management (CRM) membership type, products purchased, interests and preferences and such that may, in one embodiment, be stored in a different set of servers for big data. This may be the case when the recipient records have undergone augmentation as the campaign engine accumulates campaign activity data against these recipients.

Recipient data may be input into the system 10 through several ways. One way is through manual entry where recipient data is typed or simply copied and pasted. Another way is by uploading of a comma-separated values (CSV) file or an Extensible Markup Language (XML) file. Yet another method is through the specification of an external remote data source (including connection details) such as, for example, SalesForce, Structured Query Language (SQL) server databases, Oracle, Open Database Connectivity (ODBC) connections or File Transfer Protocol (FTP) connections. Advantageously, this facilitates aggregation of unstructured data from external sources and enrichment of recipient lists through data from external sources.

Segmentation may be performed on the recipient records based on filter conditions to create recipient lists. Tailored recipient lists may be created by applying filters such as source of the recipient 20, contact import type, demographics, geographical location, psychographic attributes, online behaviour, most active communication channel or contact stage or from recipient lists imported into the databases 16 using sources such as comma-separated values (CSV) or Extensible Markup Language (XML) files or from external stores such as databases (for example, Structured Query Language (SQL) server databases and Oracle) as well as through application programming interfaces (APIs) from platforms such as Salesforce. The selected filters for list segmentation are applied to the recipient data and as such a new recipient list is created. The filters may be applied on primary or secondary data or using a combination of both. During the recipient list selection, the system 10 stores the definition of the list alone, as opposed to the actual recipient records that form this list.

When importing a recipient list, the system 10 performs an automatic mapping of the source data by mapping the field to the source database column names to extract the recipient list. The system 10 may also allow for custom fields to be created. Following this basic mapping, a data cleansing process is initiated particularly for enterprise accounts using a third-party application programming interface (API). The user may also override the existing matched data or ignore the changes. As a last step in this process, the data selected is uploaded into the system 10. In one embodiment, structured data from a cleansed list is poured into a relational database (with 256-bit encryption), while unstructured data is poured into a big data database with data masks. This segregates the recipient data into structured and unstructured data. If recipients 20 in the list have not double-opted in, a communication is sent to the account to encourage opt-in.

In an alternative embodiment, from a recipient listing page, a user can directly create a recipient list for a specific campaign or duplicate existing lists. The created recipient list details may include a total blast or optimized view, subscriber details, an average open rate and channel behaviour.

The segments may be used to target a unique set of recipients. Recipient list segmentation makes it possible for marketers to efficiently target specific markets for a given campaign or activity from the entire recipient list by using segmentation (business-to-business (B2B) and business-to-consumer (B2C)) attributes.

In the embodiment shown, the system 10 includes a plurality of servers 12 and a plurality of databases 16. Nevertheless, as will be appreciated by those of ordinary skill in the art, the present invention is not limited by the number of servers 12 or databases 16 provided. In alternative embodiments, the system 10 may include fewer or more servers 12 and/or databases 16.

A user of the system 10 may be an agency or a brand. In the present context, an agency is an entity that manages client accounts and is responsible for creating and sending campaigns on behalf of the client accounts, and a brand is a company that may have many departments or corporate groups that may manage campaigns and users themselves.

Prior to first use, a user is required to perform a one-time account setup in order to be subsequently able to log in to the system 10 as either an agency or a brand.

To set up an account for an agency, an agency user signs up online and receives a validation email. On validating the email, the agency user is able to log in to the system 10 to set up the agency account. Agency account setup first requires input of basic data such as account ownership details (for example, general contact details and an access password), agency details (for example, agency contact details and a reports setup) and localization settings (for example, currency, language, a date format and a time zone). The agency user may then select an account type for the agency. In one embodiment, three (3) types of account packages are provided: a free usage package, a professional package and an enterprise package. The professional and enterprise package accounts require setup of corresponding client accounts before any payment can be made. In the case of enterprise package accounts, payment processes may end with the generation of an additional electronic invoice for the agency. Additionally, enterprise package accounts may also allow specification of details of a parent company that could in turn help facilitate consolidated reporting. Once the desired account type is selected and any necessary payments made, a key is sent to a registered mobile number of the agency user that is subsequently entered into the system 10 to complete the setup of the agency account.

To set up an account for a brand, a brand user signs up online and receives a validation email. On validating this email, the brand user is able to log in to the system 10 to set up the brand account. Brand account setup first requires input of basic data such as account ownership details (for example, general contact details and an access password). The brand user may then select an account type for the brand. In one embodiment, three (3) types of account packages are provided: a free usage package, a professional package and an enterprise package. For all three (3) types of account packages, the brand user is required to specify localization settings (for example, currency, language, a date format and a time zone), with enterprise package accounts being allowed to specify one or more preferred regions as well. Additionally, the professional and enterprise package accounts are also required to complete a user report access setup and to set up corresponding client accounts for making payments. In the case of enterprise package accounts, payment processes may end with the generation of an additional electronic invoice for the brand. Once the desired account type is selected and any necessary payments made, a key is sent to a registered mobile number of the brand user that is subsequently entered into the system 10 to complete the setup of the brand account.

Once an agency or a brand is set up as an entity within the system 10, campaigns may be created and executed on behalf of the entity by authorised users using various software modules of the system 10 that are made available to the authorised users via the client computer 18 upon logging into the system 10. The various software modules that may be provided with the system 10 will now be described below.

In one embodiment, a brand module and an agency module may be provided to deal with the setup and settings of the entity as well as the clients and companies under its scope.

In the same or a different embodiment, a recipient module may be provided to add and manage the recipients 20 and perform segmentation of recipient lists so as to target campaign messages and notifications to a select group of recipients 20. The recipient module enables creation, segmentation and management of campaign recipients to target campaigns effectively.

In the same or a different embodiment, a campaign module may be provided to manage the creation, configuration and execution of campaigns across different communication channels such as, for example, email, mobile Short Message Service (SMS), social media and Quick Response Codes (QR codes) according to a specified campaign flow.

In the same or a different embodiment, a dashboard module may provide users of the system 10 a single, consolidated view of relevant information such as, for example, overall performance across active campaigns, recipient behaviour, campaign history, trends and social scores of participants, specific to a logged in user. The dashboard module may be automatically displayed to a user on logging in.

In one embodiment, on first login, users may be shown a launch pad that provides instructions on using the system 10. For subsequent logins, users may be shown a dashboard comprising the performance of their active campaigns (for example, a list of recent active campaigns with corresponding performances), return on investment (ROI) trends (for example, the ROI for a selected time period), lead sources (for example, leads generated by different data sources), channel performance (for example, overall channel performance by time duration), recipient behaviour (overall recipient behaviour for each day in a week), top performing campaigns, top revenue campaigns, a list of customer advocates (for example, active participants by campaign) and an average conversion time (for example, the time taken to convert each conversion for every channel). The launch pad and dashboard login views may be the same for all types of accounts. Common information elements for all users may include active campaigns, return on investment trend, leads generated by source, channel performance, recipient behaviour, top performing campaigns, top revenue campaigns, advocates and average time conversion. In addition to these elements, business-to-business (B2B) related users may exclusively access data related to overall performance by industry and overall segment performance, and business-to-consumer (B2C) related users may exclusively access data related to online reputation management (for example, positive, negative and neutral sentiments in percentages) and demographic participation by age and/or gender. The information displayed via the dashboard module may be filtered using parameters such as clients (for agencies) or departments (for brands), as well as a stipulated time duration.

Advantageously, the dashboard module provides aggregation of data and information collection spanning campaigns, users and trends as part of a single dashboard, visual representations of the data for easy understanding and customized views with unique data elements for business-to-business (B2B) versus business-to-consumer (B2C) viewers.

In the same or a different embodiment, a reports module may provide four types of reports: a campaign summary report, a complete user analytics report, a benchmark report as well as a trend analysis report.

In the same or a different embodiment, a preferences module may be provided to address four (4) areas of preferences: general preferences (for example, profile and account settings, roles and permissions, clients/companies, users, benchmarks and campaign goals), setup preferences (for example, message settings, analytics, social media, subscription form, un-subscribe, double opt-in, alerts and notifications and system integration), tool preferences (for example, campaign job queues and application performance monitor), and billing preferences (for example, payment settings, invoice and license information).

In one embodiment, an agency user may employ the preferences module to add a new client. As part of the new client setup process, the agency user may specify, for example, a client account type (for example, free account, professional account or enterprise account, with each of the options stipulating a certain level of access for the client users when logged in to use the system 10), client details including industry and business type as this will help aggregate trend data for the reports, client users with differing access rights to the system 10 based on the client account type, and reports with specific localization settings and unique report uniform resource locators (URLs). Advantageously, this facilitates client enablement with varied account types, associated user logins, localization settings and customized URLs for direct report access.

In the same or a different embodiment, a brand user may employ the preferences module to add a new enterprise company for a brand. As part of the new enterprise company setup process, the brand user may specify, for example, company details including their industry, region, business type and/or departments as this will help aggregate trend data for the reports, company users with stipulated access rights to the system 10, and reports with specific localization settings and unique report uniform resource locators (URLs). Advantageously, this facilitates company enablement with associated user logins, localization settings and customized URLs for direct report access.

Having described the various elements of the system 10 for running a marketing campaign, a method of running a marketing campaign with the system 10 will now be described below.

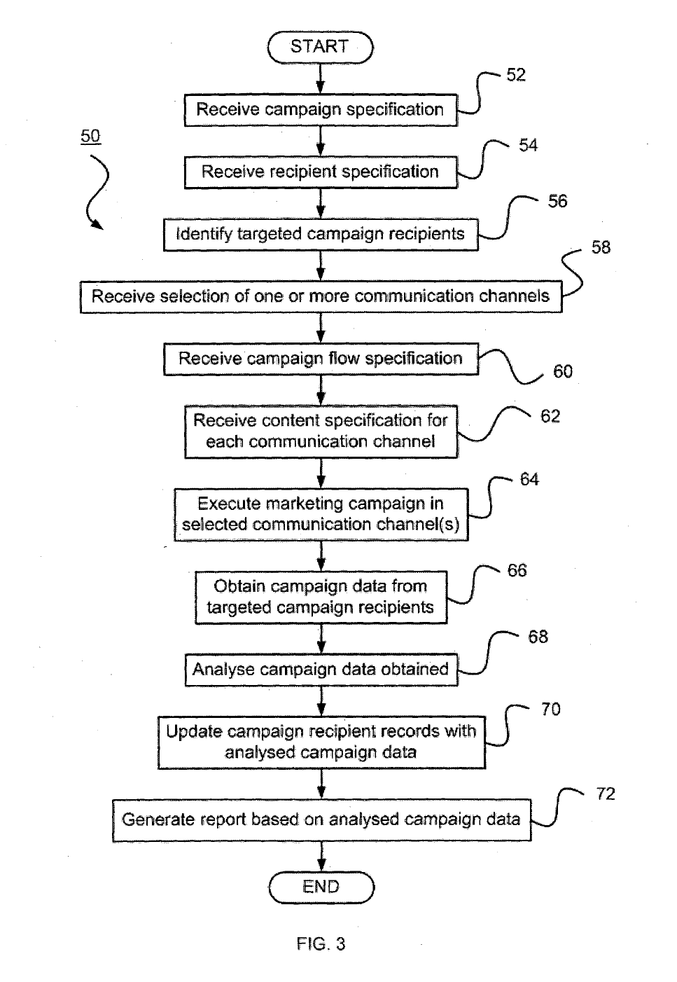

Referring now to FIG. 3, a method 50 of running a marketing campaign is shown. The method 50 is performed by one or more servers 12 communicatively coupled to the computer network 14. The method 50 begins at step 52 when a campaign specification is received by the one or more servers 12 from the client computer 18. The campaign specification specifies one or more attributes of the marketing campaign. The one or more attributes of the marketing campaign may include one or more of a campaign name, one or more campaign objectives, a tracking duration and a benchmark. In this manner, a campaign may be defined using a set of attributes such as, for example, a name, one or more objectives of the campaign, a tracking duration and a benchmark for comparison.

The one or more campaign objectives may be configurable and may include one or more of awareness, a new product launch, a promotion and a sale. The campaign objective may be used to measure the performance of a campaign at the end of a time period. The campaign objective may also be used to measure the return on investment (ROI) of a campaign based on the objectives defined. The objectives may be a set of options that can be configured based on different industries.

The tracking duration of a campaign specifies a time period for which data is aggregated as part of the campaign.

The benchmark is the standard against which the campaign performance or results is compared. The benchmark may be one of an earlier campaign result and an industry specific best result. In one embodiment, to add a benchmark to a global list, an administrator selects a country and a channel and inputs benchmark values against different metrics provided. In the same or a different embodiment, the benchmark selected may be a campaign result from a list of previously run campaigns by the same user, a specific industry's best results stored in the one or more databases 16 or any other well performing or “golden” campaign that a user selects from a campaign list stored in the one or more databases 16 that the user has access to. A campaign may be marked as a ‘golden’ campaign for future benchmarking. Advantageously, benchmarking to specific industries shows performance against meaningful metrics—business intelligence for maximizing value across every marketing dimension, online and offline.

At step 54, a recipient specification is received by the one or more servers 12 from the client computer 18. The recipient specification specifies one or more desired attributes of the targeted campaign recipients 20. The one or more desired attributes of the targeted campaign recipients 20 may include one or more of recipient contact details, geographical location, demography, online behaviour, channel activity level, campaign activity level, psychographic attributes, professional information, contact stage, customer relationship management membership type, purchasing history, one or more interests, one or more preferences and a customer propensity indicator. The customer propensity indicator provides a measure of the likelihood of specific recipients 20 responding to campaigns across each individual communication channel. The propensity value is pre-calculated as part of information aggregation at the database level by applying standard algorithms and stored against the dual parameters of call-to-action (reach, engagement and conversion) as well as the channels (email, mobile, social media).

In the present embodiment, the one or more servers 12 identify at step 56 the targeted campaign recipients 20 by filtering the potential campaign recipient records stored in the one or more databases 16 based on the one or more desired attributes of the targeted campaign recipients 20 specified in the recipient specification. Advantageously, this allows the system 10 to assist the user in selecting the most appropriate recipient lists and records with advanced audience clustering, segmentation and targeting, leading to increased conversions.

At step 58, a selection of one or more communication channels in which to run the marketing campaign is received by the one or more servers 12 from the client computer 18. The one or more communication channels may include one or more of electronic mail, one or more text messaging services, one or more social media channels (for example, Facebook, Twitter, Instagram, Youtube, Pinterest, Google+) and one or more Quick Response Code (QR code) channels.

A campaign flow specification is received by the one or more servers 12 from the client computer 18 at step 60. The campaign flow specification specifies an order in which to execute the marketing campaign in the one or more communication channels. The order in which to execute the marketing campaign in the one or more communication channels may be one or a combination of sequential execution, simultaneous execution, event-based execution and conditional branching-based execution. A trigger for event-based execution may be configurable and may be one or more of a new customer, a new order, a new invoice, an abandoned shopping cart and a wish list selection. The campaign flow specification may also specify a frequency for executing the marketing campaign.

In one embodiment, the campaign flow is determined based on the type of campaign selected. In one embodiment, the campaign may be single-dimensional, multi-dimensional or event triggered. In the case of a single dimension campaign being selected, the flow definition is serial across the channels selected. For multi-dimensional campaign flows, this information includes attributes such as the number of channels, the sequence of using the channels, if/else branching based on an action taken or not taken by the recipients 20 at different junctures.

A single-dimensional campaign type uses a singular, linear approach to reach the targeted recipients 20 through the selected one or more communication channels. When running a single dimensional campaign, a user specifies the channel selected, enables the corresponding analytics, and provides the campaign attributes and duration.

In the case of an email campaign, a user is able to create and personalize the content when setting up a campaign by using templates, rich text or with a self-imported file. There is also a subject line NB testing facility that can be used when sending email campaigns.

In the case of a mobile Short Message Service (SMS) campaign, the SMS content may be previewed through a test message before the content is sent.

In the case of a social media campaign, a specific social media channel may be chosen and the content pushed to the target recipients 20 following a preview.

In the case of a QR code campaign, after selecting the QR code type, an optional double opt-in feature may be enabled. Through this, a recipient 20 enters the recipient particulars and checks a box to receive further contact, thus becoming double opt-in verified in the recipient list.

While setting up a single-dimensional campaign, analytics tracking may be simultaneously enabled for social media profiles, web as well as sentiment online reputation management (ORM) analysis. For social media analytics, an individual account page may be tracked. For web analytics, conversion tracking must be setup. Sentiment analysis requires entry of keywords to track after entering an ORM profile name.

A multi-dimensional campaign may be setup for one or more channel types such as email, mobile, social media and/or QR code, using a multi-linear approach to reach the target audience.

To run a multi-dimensional campaign, the campaign is first defined using a name, campaign attributes or objectives (for example, awareness, new product launch, promotion or sale) and the campaign duration. From this point, a drag and drop campaign canvas may be provided on a display of the client computer 18 to allow a user to visually lay out the campaign progression.

The user begins by selecting a recipient list and multiple channels for the campaign. Following this, the content and schedule for each of the channels selected is created. By laying out the campaign progression, it is possible for users to set up a series of reminder emails or Short Message Service (SMS) after a specified number of hours, weeks or days from the original campaign blast. These triggered responses would only be blasted to recipients 20 who had not completed the specified action of the original campaign, or acted on the first reminders. A maximum of two reminders per action may be set. For example, in an ecommerce context, if a campaign is not clicked, the recipient 20 receives two reminders to initiate a purchase. Following this, in the case of an abandoned cart, additional reminders may be configured to re-target a recipient 20 via the same or a different communication channel. Recipient actions in case of successful sales or abandonment are logged back with the system 10 for aggregation. Similarly, in the case of being directed to a landing page on the web or a social media channel, reminders may be set up in the event campaign goals are not achieved. Advantageously, the system 10 provides conditional triggering of campaign actions such as reminders, across multiple channels, and the ability to interface with campaign destinations and to track and aggregate user actions from campaign destinations.

In one embodiment, the system 10 may be used to drive an ecommerce site using email and mobile SMS to reach out to audiences. In such an embodiment, the system 10 checks for email and SMS activity and responds to a successful sale, an unsuccessful drive to either the email or SMS site, and cart abandonment.

In another embodiment, the system 10 may be used to drive to a landing page with a file download call-to-action using mobile SMS and QR code to reach out to the audiences. In such an embodiment, the system 10 checks for SMS and QR code activity and responds to a successful download, an unsuccessful drive to the landing page either via SMS or QR code, and a call-to-action that is not executed.

In yet another embodiment, the system 10 may be used to drive to a webinar attendance using a subscription form to register for a webinar. In such an embodiment, the system 10 checks for webinar activity and responds to a successful subscription and download of a webinar calendar, an incomplete download that may be followed up with email and SMS reminders, and a failure to attend the webinar that may be followed up by an SMS reminder.

In an event trigger campaign, the trigger campaign results from changes in customer behaviour or specific actions which initiate a communication targeted specifically for a particular audience. For example, purchases made on a site, use of a Facebook app or posting a tweet may result in triggering the system 10 to send out a ‘thank you’ email or other communications.

Setting up an event trigger campaign may involve defining a campaign name, selecting a trigger source, a trigger type and a subsequent communication channel to reach a target audience. This may be followed by setting up the campaign duration and frequency, selecting the right time zone and creation of campaign content. Content for the campaign may be set up based on the channel selected. The flow for content creation may be channel specific. Once these are done, the campaign may be previewed and saved to be launched based on the triggers set. Advantageously, the system 10 provides the ability to set up a campaign based on a trigger, integrate external trigger sources to initiate campaigns, deliver the trigger based campaign across multiple channels, and internally aggregate recipient information from campaigns executed previously to make segmentation effective and feasible.

At step 62, a content specification for each of the one or more selected communication channels is received by the one or more servers 12 from the client computer 18. The content specification specifies content to be sent to the targeted campaign recipients 20. The content for the one of the one or more selected communication channels may be received in different formats.

Once fully defined, the marketing campaign is executed at step 64 in the one or more selected communication channels by the one or more servers 12 according to the specified order. The execution, based on the definition of the campaign, may be immediate. In one embodiment, the system 10 may trigger the campaign to run on a defined schedule at a later date or time or as a result of an external stimulus that has been defined and that the system 10 detects. The system 10 may leverage a Simple Mail Transfer Protocol (SMTP) server in the case of email campaigns and third party service provider(s) in the case of mobile text messaging campaigns. The SMTP server provides messaging services for email campaigns and notifications. In the case of social media, the system 10 may leverage the channel handles and application programme interfaces (APIs) to execute postings. In the case of social media campaigns or apps, the token associated with these may be used as input parameters when connecting to individual channels.

For web analytics campaigns, the system 10 readies to start receiving data from the defined target channels, through interfaces that have been established using web analytic tools.

For Online Reputation Management campaigns, the system 10 readies to receive data on the keywords defined through interfaces that use crawlers to capture the information and pour it into the databases 16.

In order to send communication messages to a huge volume of recipients 20, the system 10 maintains process managers to assess the load on the servers 12 and service jobs in the queue. The managers dynamically instantiate processes on identified servers 12 depending on the expected load. During sessions when a lot of communication is to be made to the recipients 20, the system 10 may instantiate these processes and purge when the peak period is over. These processes may also take on the jobs of generating the recipient records corresponding to the recipient list definition (with specified segmentations, if any), before delivery of the campaign.

On campaign execution, the system 10 tracks the campaign performance, as well as recipient actions. At step 66, campaign data is obtained from the targeted campaign recipients 20 by the one or more servers 12. The system 10 may interface with external sources such as, for example, ecommerce solutions such as Shopify, BigCommerce, Magento, as well as social media channels such as Facebook and Twitter, at the backend to pull in campaign data as part of campaign tracking. The campaign data obtained from the campaign recipients may include recipient activity information. The recipient activity information obtained from the campaign recipients 20 may be encrypted.

In the case of email and mobile text messaging campaigns, the system 10 receives recipient activity information through established interfaces. The activity information may include campaign delivery, opens, click-throughs, links clicked, tracking on target online properties that were defined as part of the campaign setup such as landing pages, resource downloads, online forms. For example, when a user clicks a link, information such as recipient id, campaign id and link id are passed back to the system 10. These ids may be encrypted for security reasons.

In the case of an analytics campaigns (web, social media, online reputation management (ORM)), the system receives channel activity information through established interfaces. The activity information could include visitor information, links clicked, time spent, activities performed.

In one embodiment, the one or more servers 12 are configured to monitor for a response from each of the campaign recipients 20. The one or more servers 12 may be further configured to send one or more response reminders if the response is not detected after one or more predetermined time periods.

The campaign data obtained from the campaign recipients 20 is analysed at step 68 by the one or more servers 12. The campaign activity data received may be acted on by defined scripts, based on algorithms that segregate and consolidate the data before storing them into the databases 16 for reporting. Scheduled processes may apply data modelling and predictive analysis techniques to sift through the data, derive patterns, extract information and publish intelligent and specialized reports, pertaining to user requests. In one embodiment, the one or more servers 12 may be configured to apply the obtained campaign data to one or more models stored in the one or more databases 16 to assess a correlation of activity across the one or more communication channels. The one or more models may be triggered to assess the correlation of activity across channels to provide enhanced marketing information on campaigns, recipients 20 and trends and provide, for example, recommendations on how to evolve the campaign. In the same or a different embodiment, the one or more servers 12 may be configured to measure a performance of the marketing campaign at an end of the tracking duration based on the one or more campaign objectives.

In the present embodiment, the one or more servers 12 are further configured to update at step 70 the campaign recipient records stored in the one or more databases 16 with the analysed campaign data. The result of this processing updates the system databases 16, in particular, the recipient records with additional recipient data gleaned (for example, customer propensity), campaign information with activity data in comparison with industry and benchmark. For new business-to-consumer (B2C) users, the recipient list may be augmented with demographic details of the recipients 20 as well as any details related to sentiment analysis that may be inferred. For new business-to-business (B2B) users, the recipient list may be augmented with geography and job function details of the recipients 20. The system 10 thus serves as a self-learning platform on campaign and industry specific marketing automation.

In one embodiment, the servers 12 may be configured to process received data (structured from users directly as well as structured and unstructured from external sources) and inject the processed data into structured and/or unstructured storage. In one embodiment, structured data from the structured storage database is also pushed into the unstructured storage database as part of internal processing to make the unstructured storage database a complete and comprehensive repository of all data on the system 10. 256-bit encryption and masked identifiers (IDs) may be applied in pushing the data from the structured storage database to the more generic unstructured storage database to ensure data security and integrity.

At step 72, a report is generated by the one or more servers 12 for the client computer 18 based on the analysed campaign data received. The report may be invoked and displayed to a user in response to a report request. When a report request is received by the system 10, data is queried from the databases 16 and retrieved. The report may be customized for specific industries. Prior to presentation of the report, a report interface is constructed based on the type of report requested and a specific industry of the requestor. Before displaying the report, the system 10 may call on charting and visualization tools to render parts of the data in formats such as predefined charts, icons and images. The system 10 may be configured to display descriptions and terms (or labels) on the report applicable to the specific industry of the requestor, while laying out the corresponding data retrieved in a standard format of the requested report.

The report may be viewed online or offline, the latter form downloaded as a PowerPoint presentation, a Portable Document Format (PDF) document or HyperText Markup Language (HTML) pages. The system 10 may provide an option for a user to email the HTML version as an interactive report.

A user may request different information sets from the system 10. The report may include one or more of a reach metric, an engagement metric, a conversion metric, a top performing location metric, a top performing audience segment metric, an acquired new users metric, a primary target audience performance metric, a secondary target audience performance metric, a return on investment metric and one or more recommendations. The report may be generated in the form of one or more of a campaign summary report, a benchmark report, a trend analysis report and a user analytics report.

A campaign summary report may be displayed in multi-layer format and may include the reach, engagement and conversion achieved by the campaign. The campaign summary report may highlight the top performing locations and audience segments (for business-to-business (B2B) sectors only), including new users acquired through the campaign. The campaign summary report may display one or more of performance of primary or secondary target audiences, the return on investment (ROI) based on campaign setup, recommendations based on inferences made from the campaign results, a graphical view of the analytics based on a time duration filter specified, a benchmark comparison of results based on a selected benchmark, and a graphical view of point of sale (POS) data that can be imported into the system 10 and viewed in conjunction with the campaign performance. A user may be able to input notes at selected points of a graph. The campaign summary report may start with a single-page view of the most important metrics, before diving deeper for more detailed views, giving practical recommendations, and creating and sharing reports with one click.

The campaign summary report may also be configured to render metrics specific to an industry. In one embodiment, a campaign summary report customized for the retail sector may be rendered. For the retail sector, the campaign summary report may include, on top of common elements applicable to a generic report, new user information that includes demographic information with Industry specific campaign metrics such as average purchase values and retention rate, brand perception or sentiment analysis data accompanied by retail specific data such as footfall to sales conversion data with the point of purchase, and performance information with customized retail specific recommendations.

The benchmark report may be generated by the one or more servers 12 by comparing the campaign data obtained from the campaign recipients 20 against a benchmark specified in the campaign specification. A user may access the campaign summary report to compare benchmarks. Benchmarks may be selected based on industry from a global list or individually selected. Individual benchmarks may be from a list of past campaigns executed by the user, other campaigns that the user is able to view or a ‘golden’ campaign set earlier. The comparison may be done across attributes like reach, engagement and conversion. A bar chart may be displayed at the end to show the comparison.

The trend analysis report allows users to compare trends across campaigns. The trend analysis report may be generated by the one or more servers 12 by comparing the campaign data obtained from the campaign recipients 20 against a trend retrieved from the one or more databases 16. The campaign to compare a trend with may be selected from, for example, the same campaign with a different time duration, a ‘golden’ campaign or any other accessible campaign from campaign list. This may be followed by a selection of attributes, channel and time duration for the trend comparison. The trend analysis report may provide one or more of a comparison at a channel level, a conversion rate for each channel, a channel performance and return on investment (ROI) charts.

The user analytics report may include an overview and a detailed user report. In one embodiment, the user analytics report may include an overall user activities component indicating user reach, engagement, conversion and virility quotient. The overall user activities component may also show users purchase path, behaviour and top channels by performance. The persona path to purchase may trace the route that targeted audiences within recipient lists have taken from receiving communications to fulfilling calls to actions. In the case of integrated campaigns across multiple channels, the path may detail the split of audience actions from various recipient lists across different touch points right up to the point of campaign goal fulfilment or en route abandonment. In the same or a different embodiment, the user analytics report may specify the top fifty (50) visitors, their segment and display visitors as advocates, spectators, influencers or critics. For each user in these lists, the report can delve down to details such as lifetime value, timeline of activities and personal connections (within the social network). The visitor data may be generated using time and campaign filters. Advantageously, the user analytics report provides an ability to view user stats, activities and behaviour at channel level and to view down to individual user details, connections, lifetime value and other metrics.

As is evident from the foregoing discussion, the present invention provides a computer-implemented method of and system for running a marketing campaign that provide a common platform over which digital communications from a brand to its audiences can be managed, tracked and measured across one or more channels. The marketing automation platform of the present invention enables users to import recipients, create campaigns and measure the outcome across a plethora of channels. The present invention consolidates data across these channels, analyses them and provides insights at a consumer level in a business-to-consumer (B2C) world and at the customer level in a business-to-business (B2B) world. At an enterprise level, the present invention is capable of integrating with internal ecommerce, content management or application systems to pull in data that may then be consolidated to produce specific reports and data views. At a user level, the present invention facilitates marketers from brands as well as agencies who might span multiple industries. The present invention provides interfaces and mechanisms for the marketer to setup and execute marketing campaigns, track the performance of the campaigns and then analyse the performance individually or in comparison, at micro as well as macro levels.

The present invention addresses the challenges of managing multiple channel marketing by providing a single, unified framework that caters to email and SMS marketing, QR codes and Online Reputation Management. The present invention allows marketers to configure single dimensional and multi-dimensional marketing campaigns, in other words action based channel strategy and transaction triggered based campaigns, that can be sequenced across email, mobile, and social media channels, aggregate campaign details across channels and provide a holistic view of campaign progress, provide in-depth analysis—both quantitative and qualitative—of brand sentiment, campaign performance, and consumer behaviour, and highlight actionable insights to help brands improve the performance of subsequent communications programs.

In addition to providing a unified framework to seamlessly manage marketing campaigns across email, mobile, and social media, the present invention may also be packed with a suite of multi-market, multi-channel module features that add considerable value including multi-lingual capabilities supporting single and double byte languages and both left-to-right and right-to-left reading languages, a campaign benchmarking facility for email and mobile campaigns with the ability to choose benchmarks, big data analytics including complete consumer analytics offering a single view of individual consumers across email, mobile, and social media, demographic and psychographic patterns of consumers across channels, and predictive analysis and insights based on a selected set of campaign data, through application of statistical models, the ability to integrate with any common database or existing or legacy system through APIs to facilitate reporting, and comprehensive reporting options including campaign summary and detailed reports on campaign performance and analytics.

The present invention offers tangible commercial benefits to businesses as well as intangible benefits that translate into increased customer lifetime value. The tangible value includes reduced costs resulting from a consolidated marketing investment across multiple channels, reuse of a common framework, configurations and shareable resources, optimization of human resources that need only master one marketing automation system and liaise with single points of contact and support, a “Pay as you use” model that eliminates the need for up-front investments on campaigns, and optimization of media spend based on analytics with more precise targeting and more efficient use of dollars, increased revenue due to the ability to scale up from one channel to multiple channels, an improved reach across developed and emerging markets with suitable digital channels, for example, using a combination of email and mobile where marketers previously might have been restricted to one or the other, global campaigns with multi-lingual and personalization features, for example, customizing campaigns to Chinese, Korean, and Europe, the Middle East and Africa (EMEA) markets, and increased return on investment (ROI) by giving marketers the ability to understand the return on investment for every marketing dollar spent. The intangible value includes advanced targeting by helping brands reach the right customers at the right time and place, improved brand image capitalizing on inputs from the Online Reputation Management modules, big data analysis, and insight reports, and increased brand affinity, loyalty, and sense of community among customers.

The present invention provides an omnichannel marketing solution with expert marketing strategists to help generate, grow revenue, and achieve the expected ROI, sophisticated marketing analytics to turn islands of data into actionable insights to target and reach the most lucrative customers at the decisive moment. The present invention helps users understand in detail recipient wants and needs, how recipients behave, and the people recipients can influence at every critical point in the marketing and sales cycle. The present invention is able to reach and influence decision makers at the moment of greatest impact with best-in-class, behavior-based segmentation and targeting. The present invention provides innovative, industry-specific benchmarking capabilities that deliver deep insights against pre-set goals, past performance, and industry best practices. The present invention also provides a choice from multiple comparative dimensions for benchmarking including reach, engagement, and conversion. The present invention helps users gain additional insight by target segment, channel, demographics, and ROI—business intelligence for business decision making. The present invention allows consolidation of multiple data sources such as enterprise systems, file import, relational database connection, or manual copy and paste, and provides data quality assurance via automated data cleansing, de-duplication, and scrubbing.

The present invention provides for dynamic campaign creation, automating and expediting every marketing effort. With the present invention, campaigns may be planned, developed, and deployed across all channels with extraordinary ease and speed. The present invention provides action-based blueprint for total campaign mechanics in the form of easy-to-use templates with key defined attributes for flexible campaign configuration, and tailored, relevant individual experiences that target content by persona and/or individual behaviour and customize by demographics, relationship to the brand, communications preferences, and more.

The present invention allows users to know the audiences intimately, turning information into insight for strategy creation and targeted communications. The present invention is user-centred, focussing on users' specific characteristics, preferences and behaviours, and seeing who's engaged and who's a spectator. The present invention provides individual engagement by providing a summary view of each individual's interactions with the brand, lifetime value, and size of social network. The present invention is capable of viewing social connections inside and outside the lists, seeing which connections are made through a brand's data and which are new potential customers.

In terms of analysis and reporting, the present invention shows a complete story in relevant, actionable terms by providing campaign specific reports, insights across multiple benchmarks and audience understanding. Using web analytics, the present invention easily synchronizes multiple analytics platforms, tracks campaign performance, and compares with all of the brand's digital initiatives. The present invention provides sentiment monitoring, multiple language monitoring using location, industry relevant terminology, and keyword attributes, thereby gaining a deeper understanding for continuous improvement. The present invention also provides for the setting of alerts and taking of action.

The present invention also provides industry and internal benchmarking capabilities that deliver deep insights based on real-world performance. The benchmarks provide meaningful comparisons to established goals, seasonal performance, comparable campaigns, and the brand's “golden” campaign. The benchmark-based insights provide additional insight by target segment, channel, demographics, and ROI.

While preferred embodiments of the invention have been illustrated and described, it will be clear that the invention is not limited to these embodiments only. Numerous modifications, changes, variations, substitutions and equivalents will be apparent to those skilled in the art without departing from the scope of the invention as described in the claims.

Further, unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1-46. (canceled)

47. A system for transforming information provided by a computing device into computer-implementable instructions for enabling selective communications with a plurality of user computing devices, the system comprising:
a network; and
a processor in communication with the network, the processor configurable to:
establish a communication channel with the computing device via the network;
determine, from the computing device via the communication channel, information including a communication request and content data, the communication request including:
a performance metric, the performance metric being one or more metrics for use in assessing a performance of a selective communication of the content data to a plurality of user computer devices;
a recipient attribute, the recipient attribute being one or more attributes for use in selecting the plurality of user computing devices; and
a plurality of candidate communication modes, each candidate communication mode being a form of communication selectable by the processor to perform the selective communication;
derive, based on a processing of the communication request, computer-implementable instructions, the computer-implementable instructions including:
a first computer-processable indicia associated with the performance metric; and
a second computer-processable indicia associated with the recipient attribute;
perform the selective communication of the content data to one or more of the plurality of user computing devices via one or more select communication modes, the one or more select communication modes selected from among the plurality of candidate communication modes based on at least the second computer-processable indicia;
monitor the selective communication of the content data; and
derive a resultant performance metric, the resultant performance metric being a measure of the results of the selective communication based on at least a comparison of the results of the monitoring and the first computer-processable indicia.

48. The system of claim 47, wherein the performance metric includes one or more of an objective for selectively communicating the content data, a duration of the monitoring of the selective communication, and a benchmark.

49. The system of claim 48, wherein one or more of the following apply:
the benchmark includes a previous selective communication and/or industry specific best result; and
the monitoring of the selective communication is performed for the duration provided in the performance metric.

50. The system of claim 47, wherein:
the processor is further configurable to derive a propensity indicia, the propensity indicia being a measure of a likelihood that one or more of the plurality of user computing devices will respond to the selective communication; and
the selecting of the one or more select communication modes is further based on the propensity indicia.

51. The system of claim 47, wherein:
the processor is further configurable to derive a propensity indicia for each candidate communication mode, the propensity indicia being a measure of a likelihood that one or more of the plurality of user computing devices will respond to a communication via the candidate communication mode; and
the selecting of the one or more select communication modes is further based on the propensity indicia.

52. The system of claim 47, wherein one or more of the following apply:
the selecting of the one or more select communication modes is further based on the content data;
the selecting of the one or more select communication modes is further based on information associated with one or more of the plurality of user computing devices, including information pertaining to a user of each of the plurality of user computing devices; and
the recipient attribute includes a propensity indicia, the propensity indicia being a measure of a likelihood that one or more of the user computing devices will respond to the selective communication.

53. The system of claim 47, wherein the processor is further configurable to select the one or more user computing devices that will receive the selective communication, the selecting of the one or more user computing devices based on information pertaining to the user of the one or more user computing devices.

54. The system of claim 53, wherein one or more of the following apply:
the selecting of the one or more user computing devices to receive the selective communication is further based on the obtained recipient attribute; and
the selecting of the one or more user computing devices to receive the selective communication is further based on the candidate communication modes.

55. The system of claim 47, wherein one or more of the following apply:
the processor is further configurable to determine a communication sequence for the selective communication, the communication sequence being an order in which the selective communication is performed on the select communication modes; and
the candidate communication modes include communication in the form of an electronic mail, SMS, a social media platform, and/or a Quick Response Code (QR Code).

56. The system of claim 47, wherein the system further comprises a database, the database configurable to store information pertaining to one or more of the following:
users of the plurality of user computing devices;
the performance metric;
the recipient attribute;
the candidate communication modes;
results of the selective communication of the content data; and
the resultant performance metric.

57. A system for transforming information provided by a computing device into computer-implementable instructions for enabling selective communications with a plurality of user computing devices, the system comprising:
a network; and
a processor in communication with the network, the processor configurable to:
establish a communication channel with the computing device via the network;
determine, from the computing device via the communication channel, information including a communication request and content data, the communication request including:
a performance metric, the performance metric being one or more metrics for use in assessing a performance of a selective communication of the content data to a plurality of user computer devices;
a recipient attribute, the recipient attribute being one or more attributes for use in selecting the plurality of user computing devices; and
a plurality of candidate communication modes, each candidate communication mode being a form of communication selectable by the computing device to perform the selective communication;
derive, based on a processing of the communication request, computer-implementable instructions, the computer-implementable instructions including:
a first computer-processable indicia associated with the performance metric; and
a second computer-processable indicia associated with the recipient attribute;
configure, via the communication channel, the computing device to perform the selective communication of the content data to one or more of the plurality of user computing devices via one or more select communication modes, the one or more select communication modes selected from among the plurality of candidate communication modes based on at least the second computer-processable indicia;
monitor the selective communication of the content data by the computing device; and
derive a resultant performance metric, the resultant performance metric being a measure of the results of the selective communication based on at least a comparison of the results of the monitoring and the first computer-processable indicia.

58. The system of claim 57, wherein one or more of the following apply:
the processor is further configurable to derive a propensity indicia for each candidate communication mode, the propensity indicia being a measure of a likelihood that one or more of the plurality of user computing devices will respond to a communication via the candidate communication mode, the selecting of the one or more select communication modes being further based on the propensity indicia;
the selecting of the one or more select communication modes is further based on the content data;
the selecting of the one or more select communication modes is further based on information associated with one or more of the plurality of user computing devices, including information pertaining to a user of each of the plurality of user computing devices;
the recipient attribute includes a propensity indicia, the propensity indicia being a measure of a likelihood that one or more of the user computing devices will respond to the selective communication;
the processor is further configurable to select the one or more user computing devices that will receive the selective communication, the selecting of the one or more user computing devices based on information pertaining to the user of the one or more user computing devices, the obtained recipient attribute, and/or the candidate communication modes;
the processor is further configurable to determine a communication sequence for the selective communication, the communication sequence being an order in which the selective communication is performed on the select communication modes;
the candidate communication modes include communication in the form of an electronic mail, SMS, a social media platform, and/or a Quick Response Code (QR Code); and
the system further comprises a database, the database configurable to store information pertaining to one or more of the following:
users of the plurality of user computing devices;
the performance metric;
the recipient attribute;
the candidate communication modes;
results of the selective communication of the content data; and
the resultant performance metric.

59. A method for transforming information provided by a computing device into computer-implementable instructions for enabling selective communications with a plurality of user computing devices, the method comprising:
establishing a communication channel between a processor and the computing device;
determining, by the processor from the computing device via the communication channel, information including a communication request and content data, the communication request including:
a performance metric, the performance metric being one or more metrics for use in assessing a performance of a selective communication of the content data to a plurality of user computer devices;
a recipient attribute, the recipient attribute being one or more attributes for use in selecting the plurality of user computing devices; and
a plurality of candidate communication modes, each candidate communication mode being a form of communication selectable by the processor to perform the selective communication;
deriving, by the processor based on a processing of the communication request, computer-implementable instructions, the computer-implementable instructions including:
a first computer-processable indicia associated with the performance metric; and
a second computer-processable indicia associated with the recipient attribute;
performing, by the processor, the selective communication of the content data to one or more of the plurality of user computing devices via one or more select communication modes, the one or more select communication modes selected from among the plurality of candidate communication modes based on at least the second computer-processable indicia;
monitoring, by the processor, the selective communication of the content data; and
deriving, by the processor, a resultant performance metric, the resultant performance metric being a measure of the results of the selective communication based on at least a comparison of the results of the monitoring and the first computer-processable indicia.

60. The method of claim 59, wherein the performance metric includes one or more of a objective for selectively communicating the content data, a duration of the monitoring of the selective communication, and a benchmark.

61. The method of claim 60, wherein one or more of the following apply:
the benchmark includes a previous selective communication and/or industry specific best result; and
the monitoring of the selective communication is performed for the duration provided in the performance metric.

62. The method of claim 59, further comprising deriving, by the processor, a propensity indicia, the propensity indicia being a measure of a likelihood that one or more of the plurality of user computing devices will respond to the selective communication;
wherein the selecting of the one or more select communication modes is further based on the propensity indicia.

63. The method of claim 59, further comprising deriving, by the processor, a propensity indicia for each candidate communication mode, the propensity indicia being a measure of a likelihood that one or more of the plurality of user computing devices will respond to a communication via the candidate communication mode;
wherein the selecting of the one or more select communication modes is further based on the propensity indicia.

64. The method of claim 59, wherein one or more of the following apply:
the selecting of the one or more select communication modes is further based on the content data;
the selecting of the one or more select communication modes is further based on information associated with one or more of the plurality of user computing devices, including information pertaining to a user of each of the plurality of user computing devices; and
the recipient attribute includes a propensity indicia, the propensity indicia being a measure of a likelihood that one or more of the user computing devices will respond to the selective communication.

65. The method of claim 59, further comprising selecting, by the processor, the one or more user computing devices to receive the selective communication, the selecting of the one or more user computing devices based on information pertaining to the user of the one or more user computing devices.

66. The method of claim 65, wherein one or more of the following apply:
the selecting of the one or more user computing devices to receive the selective communication is further based on the obtained recipient attribute; and
the selecting of the one or more user computing devices to receive the selective communication is further based on the candidate communication modes.

67. The method of claim 59, wherein one or more of the following apply:
the method further comprises determining, by the processor, a communication sequence for the selective communication, the communication sequence being an order in which the selective communication is performed on the select communication modes; and
the candidate communication modes include communication in the form of an electronic mail, SMS, a social media platform, and/or a Quick Response Code (QR Code).

68. The method of claim 59, further comprising providing a database, the database configurable to store information pertaining to one or more of the following:
users of the plurality of user computing devices;
the performance metric;
the recipient attribute;
the candidate communication modes;
results of the selective communication of the content data; and
the resultant performance metric.
